(19) United States
(12) Patent Application Publication
(10) Pub. No.: US 2019/0384637 A1
(43) Pub. Date: Dec. 19, 2019

(54) CONTROLLER

(71) Applicant: Mitsubishi Electric Corporation, Tokyo (JP)

(72) Inventor: Kiyohito MIYAZAKI, Tokyo (JP)

(73) Assignee: Mitsubishi Electric Corporation, Tokyo (JP)

(21) Appl. No.: 16/480,319

(22) PCT Filed: Sep. 26, 2017
(86) PCT No.: PCT/JP2017/034771

§ 371 Date: Jul. 24, 2019

(51) Int. Cl. G06F 9/48; G05B 19/042

(52) U.S. Cl. CPC G06F 9/4887; G05B 19/0428

(57) ABSTRACT

A controller includes: a task execution management table in which task information including information on task priority is registered; a new task acquisition unit that acquires new task information to be added to the task execution management table; a temporary priority setting unit that changes a priority included in the new task information, to a temporary priority to temporarily register the new task information in the task execution management table; and a task execution monitoring unit that monitors an influence of execution of an additional task on execution of an existing task, the additional task being a task corresponding to the temporarily registered new task information.

### FIELD

The present invention relates to a controller for controlling a target instrument.

### BACKGROUND

Patent Literature 1 discloses a controller capable of improving user convenience, in particular, a controller capable of changing program execution conditions such as the priority and execution cycle of a task during execution of a user program. A user program executed by the controller described in Patent Literature 1 can include an instruction for changing program execution conditions. That is, in a case where a user program to be executed includes an instruction for changing program execution conditions, the controller described in Patent Literature 1 corrects at least one of the priority and execution cycle of a task, and executes the user program. The controller needs to complete each task within the execution cycle specified for each task.

### CITATION LIST

### Patent Literature

Patent Literature 1: Japanese Patent Application Laid-open No. 2015-176191

### SUMMARY

### Technical Problem

A controller that controls an instrument at a production site can undergo a setting change while executing a user program, that is, while executing a task, so as to execute a new task different from the existing task being executed. Unfortunately, existing tasks may be affected by the additional or new task set for execution, which may cause failure. For example, in a case where the controller schedules the tasks on the basis of the priorities, the execution timing of an existing task having a lower priority than the new task to be added may be delayed, resulting in failure to complete the task within a specified execution cycle. The failure to complete the existing task within the specified execution cycle causes various problems including a production shutdown, a decrease in production efficiency, and a decrease in processing accuracy in the case of controlling a cutting machine. It is therefore preferable that a new task to be executed be added only after checking in advance whether the new task affects existing tasks and determining that the new task does not affect existing tasks. The language “affect existing tasks” means that the addition of a new task for execution inhibits one or more existing tasks from being normally executed, specifically, from being completed within a specified execution cycle. In the following description, the time by which the execution of a task should be completed may be referred to as a “deadline”.

The present invention has been made in view of the above problems, and an object thereof is to obtain a controller capable of changing settings so as to execute a new task after checking in advance the influence of the new task on existing tasks.

### Solution to Problem

In order to solve the above-mentioned problems and achieve the object, a controller according to the present invention comprises: a task execution management table in which task information including information on task priority is registered; and a new task acquisition unit to acquire new task information to be added to the task execution management table. The controller further comprises; a temporary priority setting unit to change a priority included in the new task information, to a temporary priority to temporarily register the new task information in the task execution management table; and a task execution monitoring unit to monitor an influence of execution of an additional task on execution of an existing task, the additional task being a task corresponding to the temporarily registered new task information.

### Advantageous Effects of Invention

The present invention can achieve the effect of obtaining the controller capable of changing the settings so as to execute the new task after checking in advance the influence of the new task on the existing tasks.

### BRIEF DESCRIPTION OF DRAWINGS

FIG. 1 is a diagram illustrating a hardware configuration of a controller according to an embodiment of the present invention.

FIG. 2 is a diagram illustrating an example of functional block configuration of the controller.

FIG. 3 is a diagram illustrating an example of a task execution management table.

FIG. 4 is a diagram illustrating an example of a new task addition window.

FIG. 5 is a flowchart illustrating an example of how the controller operates.

FIG. 6 is a flowchart illustrating an example of how a temporary priority setting unit operates.

FIG. 7 is a flowchart illustrating an example of how a task execution monitoring unit operates.

FIG. 8 is a diagram illustrating an example of how the controller operates before adding a task.

FIG. 9 is a diagram illustrating an example of how the controller operates during execution of the operation of adding a task.

FIG. 10 is a diagram illustrating an example of how the controller operates after adding a task.

### DESCRIPTION OF EMBODIMENT

Hereinafter, a controller according to an embodiment of the present invention will be described in detail based on the drawings. The present invention is not limited to the embodiment.

Embodiment

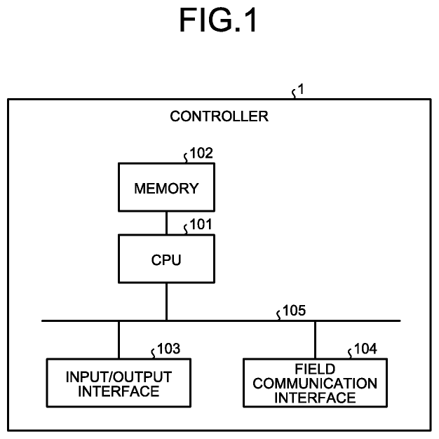

FIG. 1 is a diagram illustrating a hardware configuration of a controller according to an embodiment of the present invention. The controller 1 includes a central processing unit (CPU) 101, a memory 102, an input/output interface 103, and a field communication interface 104. The memory 102 is connected to the CPU 101. The CPU 101, the input/output interface 103, and the field communication interface 104 are connected to one another by a bus 105.

The CPU 101 executes programs such as an operating system (OS) and a user program stored in the memory 102. The input/output interface 103 is an interface for connection to a device that is to be controlled (not illustrated). In accordance with a program executed by the CPU 101, the input/output interface 103 performs input/output for input/output (I/O) control, thereby controlling the connected device. The field communication interface 104 communicates with other controllers and information systems in accordance with a program executed by the CPU 101.

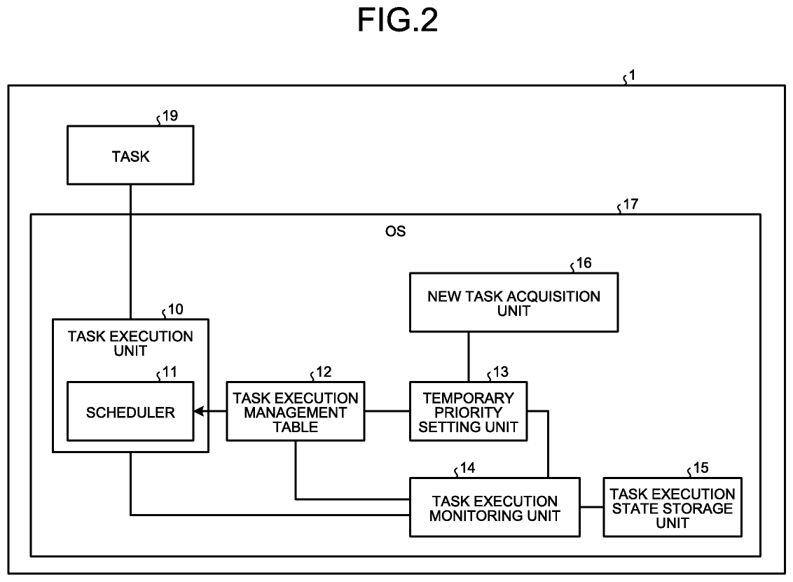

FIG. 2 is a diagram illustrating an example of a functional block configuration of the controller 1. The controller 1 includes a task execution unit 10, a task execution management table 12, a temporary priority setting unit 13, a task execution monitoring unit 14, a task execution state storage unit 15, and a new task acquisition unit 16. The task execution unit 10 includes a scheduler 11. These functional blocks are implemented by an OS 17 such as a real-time OS. A program for operating as the controller 1 is executed on the OS 17 such as a real-time OS, thereby implementing each of the above functional blocks. A task 19 illustrated in FIG. 2 is a task such as a user program that operates on a higher level than each of the functional blocks. The program is executed on the controller 1 on a task-by-task basis. That is, the scheduler 11 of the task execution unit 10 selects, on the task-by-task basis, the program to be executed next. In general, the tasks are: the task to perform system processing; and the task uniquely created by the user of the controller 1. One or more tasks are executed. The configuration of tasks to be executed varies depending on the specification and use of the controller 1, and is not limited.

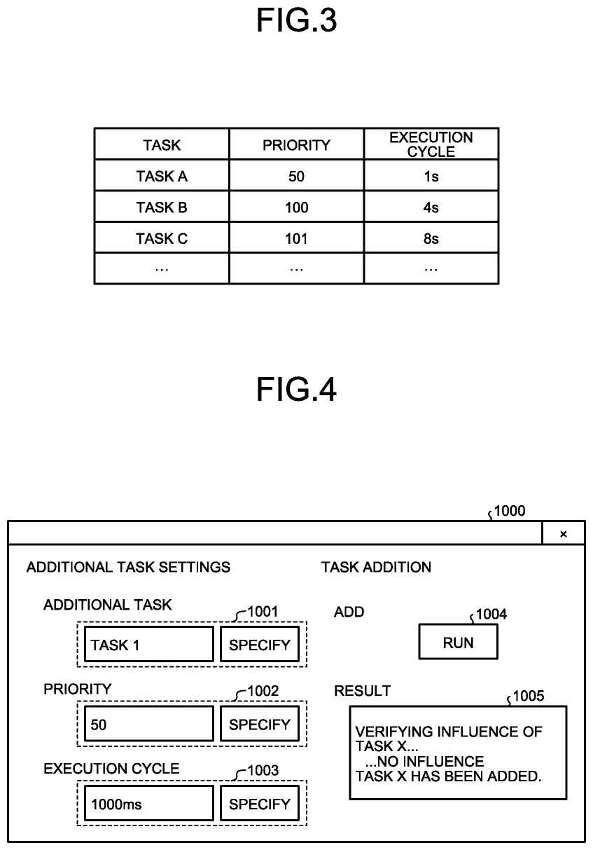

The scheduler 11 of the task execution unit 10 determines the order of execution of the tasks on the basis of the task information registered in the task execution management table 12, such that the tasks are executed by the task execution unit 10. FIG. 3 is a diagram illustrating an example of the task execution management table 12. As illustrated in FIG. 3, the task information registered in the task execution management table 12 includes the task name, the task priority, and the task execution cycle. FIG. 3 illustrates an example of the task execution management table 12 in which the task information on task A, the task information on task 13, and the task information on task C are registered. The task information registered in the task execution management table 12 can be rewritten from the outside not only during suspension of a task but also during execution of a task, so that the user can change the order of execution of the tasks. Registering the task information in the task execution management table 12 allows the scheduling of the tasks corresponding to the registered task information, such that the tasks can be executed in accordance with the scheduling. Deleting the task information registered in the task execution management table 12 can prevent the execution of the task corresponding to the deleted task information.

The priority of a task is an index for the scheduler 11 to select the task to that is be executed. The scheduler 11 selects the highest priority task from among executable tasks. The priorities of tasks range between multiple degrees, for example, from 0 to 255 degrees. The lower the degree is, the higher the priority, of the task is. The task having such a higher priority preferentially undergoes the scheduling. The scheduling that is performed by the scheduler 11 can be preemptive scheduling, i.e. a scheduling employing a scheme under which when a higher priority task becomes executable during the execution of a task, the execution is immediately switched to effect the execution of such a task higher in priority than the task being executed. For the task execution management table 12 illustrated in FIG. 3, task A has the highest priority, and task B has the second highest priority. Task C has the lowest priority among tasks A to C.

A task for the controller 1 has to be repeatedly executed, such as the task of performing feedback control at regular intervals, for example. The time interval between executions, that is, the time period from when a task becomes executable until when the same task becomes executable again, is the execution cycle illustrated in FIG. 3. The execution cycle of a task is set by the user in view of, for example, the accuracy of control required of the task. For the task execution management table 12 illustrated in FIG. 3, task A becomes executable every 1(s). Similarly, task B becomes executable every 4(s), and task C becomes executable every 8(s).

In the present embodiment, the task execution unit 10 includes the scheduler 11. Alternatively, the scheduler 11 and the task execution unit 10 may be configured separately.

Next, a description is made as to an example of how the controller 1 operates, in particular, how the controller 1 operates when the user of the controller 1 adds a new task during operations of a plurality of tasks. The task to be added has a target priority, i.e. the priority that should be set. The target priority is predetermined by the user. In view of the processing contents of the task to be added, the user determines the target priority such that the task can operate at the necessary timing. The method of determining the target priority is outside the scope of the present invention.

In adding a task to be executed by the controller 1, the user uses an engineering tool, i.e. application software for setting the controller 1. This application software is executed by a personal computer connected to the controller 1 via the field communication interface 104 illustrated in FIG. 1.

The engineering tool for setting the controller 1 displays a new task addition window 1000 illustrated in FIG. 4, in response to detecting an instruction to start the operation of adding task information to the controller. The new task addition window 1000 includes an additional task setting area 1001, a priority setting area 1002, an execution cycle specification area 1003, a run button. 1004 for accepting an instruction to start the operation of adding a task, and a display area 1005 for displaying the result of the addition. The additional task setting area 1001 is an area in which the user specifies a desired task by entering the entry point name or execution file name of the task. The priority setting area 1002 is an area in which the user specifies the original priority of a task to be added. The execution cycle specification area 1003 is an area in which the user specifies an execution cycle that should be set.

The user enters necessary information to the additional task setting area 1001, the priority setting area 1002, and the execution cycle specification area 1003. The entry of information is completed by pressing the “specify” button included in each setting area. At this time, the engineering tool may determine whether the entered information is correct if the information is incorrect, the engineering tool may, for example, display a notification to that effect, so as to prompt the user to enter information again. The entered information is considered incorrect if, for example, the entered degree of priority is not within the valid range. When completing the entry of necessary information to the priority setting area 1002 and the execution cycle specification area 1003, the user presses the run button 1004. Upon receiving this operation, the engineering tool generates task information including the entered information, that is, the name, priority, and execution cycle of the task to be added, and transmits the task information to the controller 1. As a result, the controller 1 executes processing (described later) to add the task to the task execution management table 12, that is, add the task information received from the engineering tool to the task execution management table 12. Note that, the new task acquisition unit 16 of the controller 1 receives the task information transmitted from the engineering tool. When the result of the task addition process is transmitted from the controller 1, the engineering tool displays the result of the addition process on the display area 1005 of the new task addition window 1000.

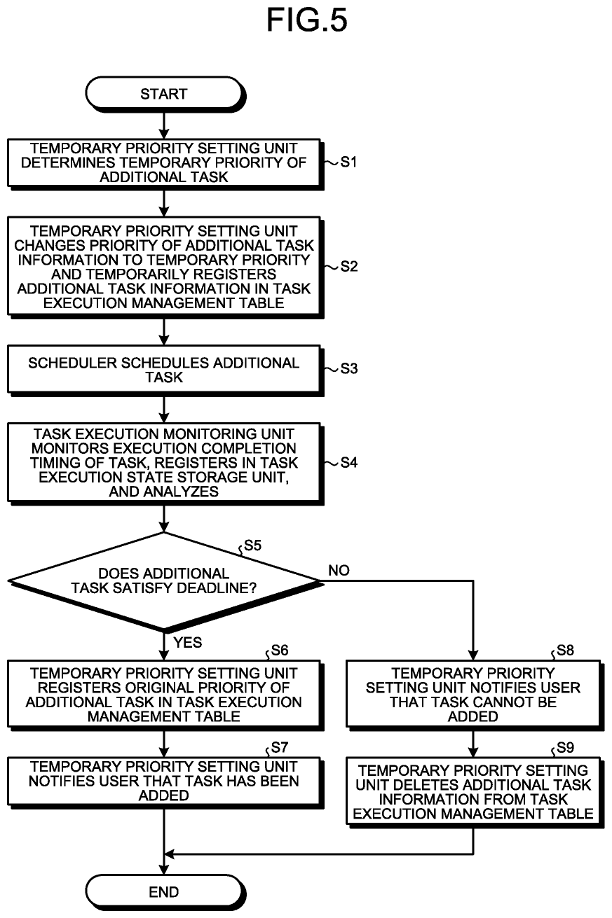

The controller 1 will be explained again. The controller 1 executes the procedure illustrated in FIG. 5 in response to receiving from the engineering tool the task information of the task to be added. FIG. 5 is a flowchart illustrating an example of how the controller 1 operates. More specifically, FIG. 5 is a flowchart illustrating the operation in which the controller 1 determines whether the task information received from the engineering tool can be added to and registered in the task execution management table 12, and registers the task information if the additional registration is possible. Note that the language “task information can be added to and registered in the task execution management table 12” means that even if a new task is executed as a result of the additional registration of task information, all the tasks can be normally executed. “All the tasks” are: a new task to be executed as a result of the additional registration of task information.; and the existing tasks that have been executed so far. The language “the task can be normally executed” means that the operations from the start of a task to the end of the task can be completed within the execution cycle included in the task information corresponding to the task. For example, in the case of task A illustrated in FIG. 3, if the time from when task A becomes executable until when task A is finished is within 1 (s), the normal execution of task A is considered successful.

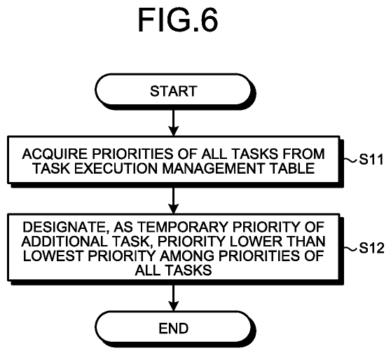

Once the controller 1 receives the task information on a task to be added, the temporary priority setting unit 13 first determines the temporary priority of the task to be added (step S1). The temporary priority is a priority to be used in the process of determining whether the task corresponding to the task information received from the engineering tool can be added. The temporary priority setting unit 13 designates, as the temporary priority, a value that does not affect the execution timings of the existing tasks. Hereinafter, the task to be added is referred to as an additional task, and the task information on the task to be added is referred to as additional task information In step S1, the temporary priority setting unit 13 determines the temporary priority in accordance with the procedure illustrated in FIG. 6.

FIG. 6 is a flowchart illustrating an example of how the temporary priority setting unit 13 operates. Upon receiving the additional task information from the engineering tool via the new task acquisition unit 16, the temporary priority setting unit 13 first acquires the priorities of all the tasks from the task execution management table 12 (step S11). That is, the temporary priority setting unit 13 acquires, from all the pieces of task information registered in the task execution management table 12, the priorities included in the pieces of task information. The temporary priority setting unit 13 then designates, as the temporary priority of the additional task, a priority lower than the lowest priority among the priorities of all the acquired tasks (step S12). The temporary priority setting unit 13 only needs to designate, as the temporary priority of the additional task, a priority lower by one than the lowest priority among the acquired priorities. That is, the temporary priority setting unit 13 determines the temporary priority of the additional task by adding one to the value of the lowest priority among the acquired priorities. If the priority of the additional task is lower than the lowest priority among the acquired priorities, the temporary priority setting unit 13 may designate the priority of the additional task as the temporary priority without any change.

Reference is made back to the flowchart illustrated in FIG. 5. The temporary priority setting unit 13 next changes the priority included in the additional task information, to the temporary priority calculated in step S1, and temporarily registers the changed additional task information in the task execution management table 12 (step S2).

Next, the scheduler 11 schedules the additional task corresponding to the additional task information temporarily registered in the task execution management table 12 (step S3). Note that the scheduler 11 also schedules the existing tasks as well as the additional task. Thereafter, the additional task is periodically executed in accordance with the scheduling result.

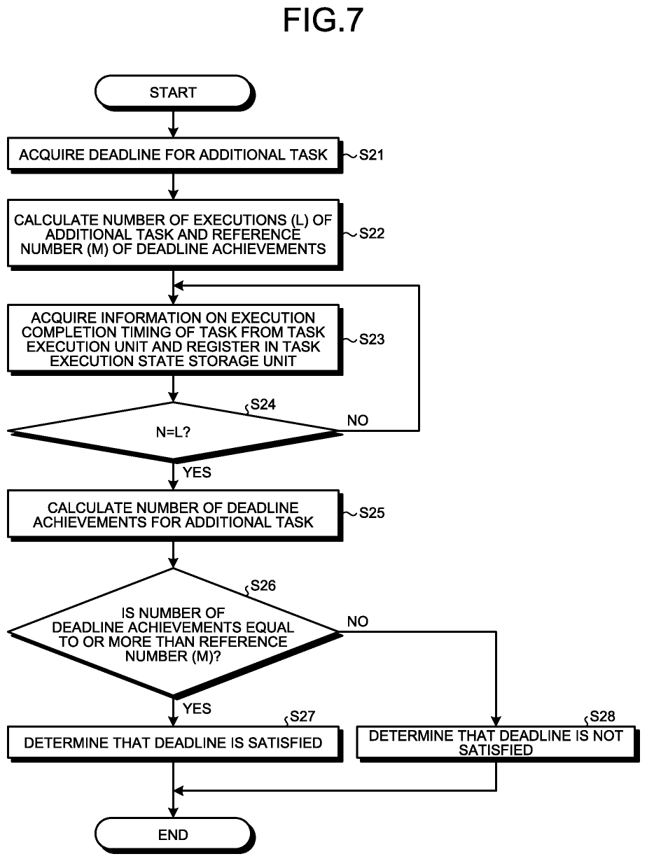

The task execution monitoring unit 14 monitors the execution completion timing of the additional task, and registers the monitoring result, that is, information on the execution completion timing of the additional task, in the task execution state storage unit 15. The task execution monitoring unit 14 also analyzes the registered information (step S4). In step S4, the task execution monitoring unit 14 executes each step illustrated in FIG. 7 to determine whether the additional task information temporarily registered in the task execution management table 12 can be formally registered.

FIG. 7 is a flowchart illustrating an example of how the task execution monitoring unit 14 operates. The task execution monitoring unit 14 first calculates a deadline for the additional task on the basis of the additional task information temporarily registered in the task execution management table 12 (step S21). The task execution monitoring unit 14 calculates the deadline by adding the execution cycle to the timing at which the additional task becomes executable. Since the priority included in the temporarily registered additional task information is lower than any priority included in the other pieces of task information, the task execution monitoring unit 14 can identify the temporarily registered additional task information from among the pieces of task information registered in the task execution management table 12. Note that the task execution monitoring unit 14 may calculate the deadline for the additional task on the basis of the additional task information output from the temporary priority setting unit 13, instead of calculating the deadline for the additional task on the basis of the additional task information temporarily registered in the task execution management table 12.

Next, the task execution monitoring unit 14 determines the number of verification actions required to determine the achievement of the deadline for the additional task. Specifically, the task execution monitoring unit 14 determines the number of executions (L) of the additional task and the reference number (M) of deadline achievements that should be satisfied (step S22). The purpose of this step is to determine the achievement of the deadline statistically appropriately in view of fluctuations in the execution time of the additional task. An exemplary method of determining the number of executions L and the reference number M includes assuming that the execution time of the additional task is normally distributed, and calculating the number of executions L of the additional task and the reference number M of deadline achievements on the basis of the reliability required by the user. This method of determining the required number of executions and the required number of deadline achievements is based on the premise that the task execution monitoring unit 14 holds in advance information on the reliability required by the user.

Next, the task execution monitoring unit 14 acquires, from the task execution unit 10, information on the execution completion timing of the additional task. The task execution monitoring unit 14 also registers the acquired information in the task execution state storage unit 15 so as to utilize the information for analysis (step S23).

Next, the task execution monitoring unit 14 checks whether the number of pieces of information registered in the task execution state storage unit 15, that is, the number (N) of pieces of information on the execution completion timing of the additional task, is equal to the number of executions (L) of the additional task determined in step S22 above (step S24). If N=L is not satisfied (step S24: No), the task execution monitoring unit 14 returns to step S23 to execute again the process of acquiring information on the execution completion timing of the additional task and registering the acquired information in the task execution state storage unit 15. If N=L is satisfied (step S24: Yes), the task execution monitoring unit 14 calculates the number of deadline achievements for the additional task (step S25). In step S25, the task execution monitoring unit 14 analyzes the N pieces of information registered in the task execution state storage unit 15, calculates the number of items of information in which the length of time from when the additional task becomes executable until when the additional task is completed is less than the deadline. Then, the number of pieces of information in which such length of time is less than the deadline is set as the number of deadline achievements by the task execution monitoring unit 14. Note that on the basis of the execution cycle of the additional task temporarily registered in the task execution management table 12, the task execution monitoring unit 14 obtains the timing at which the additional task becomes executable.

Next, the task execution monitoring unit 14 checks whether the number of deadline achievements calculated in step S25 is equal to or more than the reference number N of deadline achievements determined in step S22 (step S26). If M≤(the number of deadline achievements) is satisfied (step S26: Yes), the task execution monitoring unit 14 determines that the additional task satisfies the deadline (step S27). In a case where the additional task satisfies the deadline, all the tasks can be normally executed, that is, all the tasks satisfy their own deadlines even after the additional task is formally added. On the other hand, if (the number of deadline achievements)<M: is satisfied (step S26: No), the task execution monitoring unit 14 determines that the additional task does not satisfy the deadline (step S28). In a case where the additional task does not satisfy the deadline, one or more tasks cannot be normally executed, that is, one or more tasks do not satisfy their own deadlines after the additional task is formally added. Since the formal addition of the additional task that does not satisfy the deadline causes failure, the additional task is not allowed to be formally added.

Reference is made back to the flowchart illustrated in FIG. 5. If the analysis result provided by the task execution monitoring unit 14 in step S4 indicates that the additional task satisfies the deadline (step S5: Yes), the temporary priority setting unit 13 registers the original priority of the additional task in the task execution management table 12 (step S6). That is, the temporary priority setting unit 13 changes the temporary priority included in the additional task information temporarily registered in above step S2, to the original priority that is the priority set prior to being changed to the temporary priority. Then, the temporary priority setting unit 13 formally registers the additional task information in the task execution management table 12. The temporary priority setting unit 13 also notifies the user that the task has been added (step S7), and ends the operation. In step S7, the temporary priority setting unit 13 notifies the engineering tool via the new task acquisition unit 16 that the task corresponding to the task information received from the engineering tool has been added. As a result, the notification to the effect that the task has been added is displayed by the engineering tool on the new task addition window 1000 illustrated in FIG. 4. Note that the engineering tool displays the addition of the task on the display area 1005 of the new task addition window 1000. Note that the temporary priority setting unit 13 may simultaneously execute step S6 and step S7, or may execute step S7 before step S6. The notification to the user in step S7 may be sent by the task execution monitoring unit 14 instead of the temporary priority setting unit 13.

On the other hand, if the analysis result provided by the task execution monitoring unit 14 in step S4 indicates that the additional task does not satisfy the deadline (step S5: No), the temporary priority setting unit 13 notifies the user that the task cannot be added (step S8). In step S8, the temporary priority setting unit 13 notifies the engineering tool via the new task acquisition unit 16 that the task corresponding to the task information received from the engineering tool cannot be added. As a result, the notification to the effect that the task cannot be added is displayed by the engineering tool on the new task addition window 1000 illustrated in FIG. 4. The temporary priority setting unit 13 also deletes, from the task execution management table 12, the additional task information temporarily registered in step S2 (step S9), and ends the operation. The temporary priority setting unit 13 may simultaneously execute step S8 and step S9, or may execute step S9 may before step S8. The notification to the user in step S8 may be sent by the task execution monitoring unit 14 instead of the temporary priority setting unit 13.

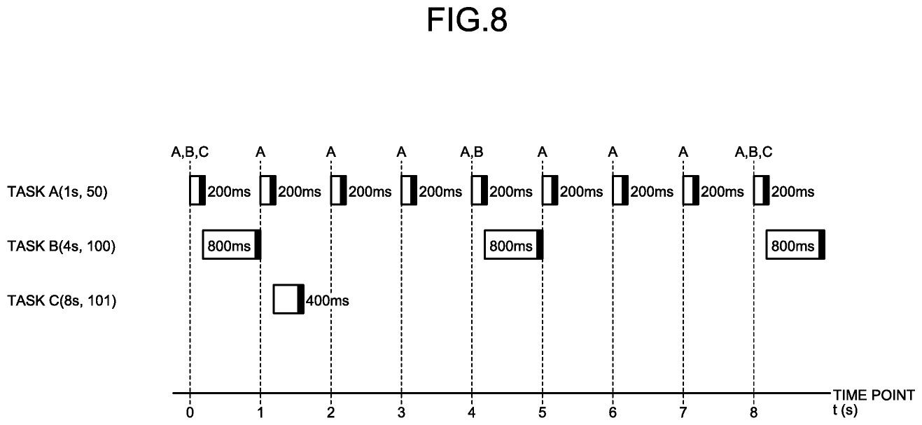

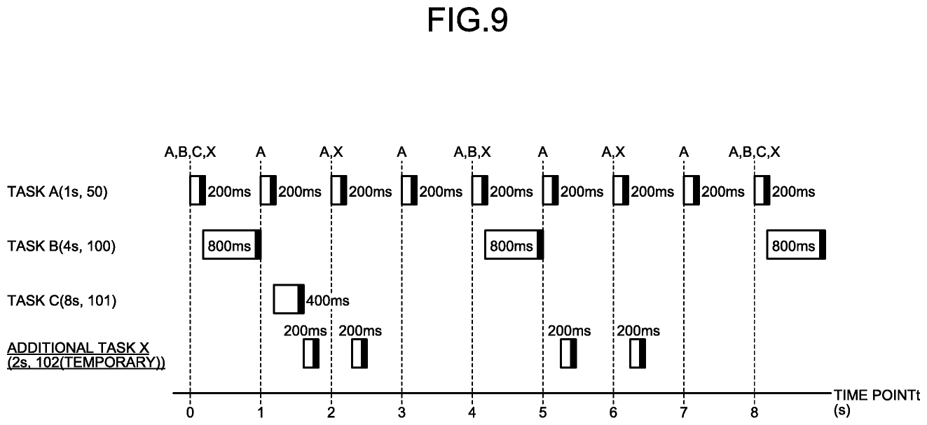

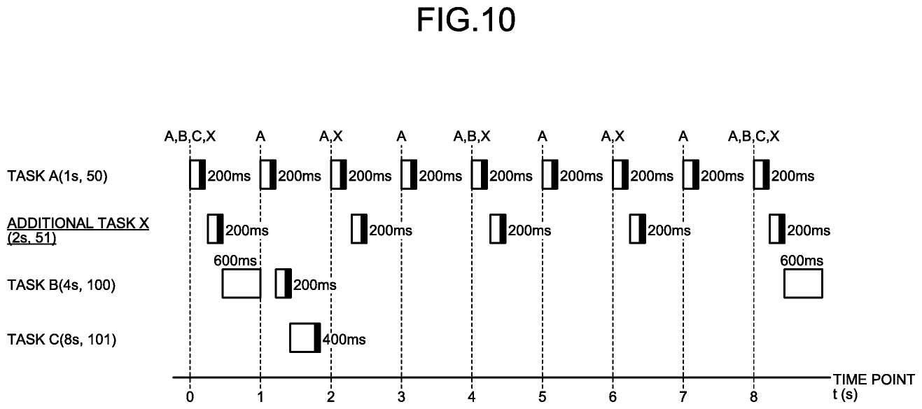

Next, a specific example in which the controller 1 executes the operation illustrated in FIG. 5 to add a task will be described with reference to FIGS. 8 to 10. FIG. 8 is a diagram illustrating an example of how the controller 1 operates before adding a task. FIG. 9 is a diagram illustrating an example of how the controller 1 operates during the execution of the operation of adding a task illustrated in FIG. 5. FIG. 10 is a diagram illustrating an example of how the controller 1 operates after adding a task. For ease of explanation, the number of verification actions for verifying whether the additional task satisfies the deadline is one.

The operation example illustrated in FIG. 8 is based on the assumption that tasks A, B, and C are executed in accordance with the task execution management table 12 including the contents illustrated in FIG. 3, and indicates which task is operating at each time point on the horizontal time axis. Task A has the highest priorty, task B has the second highest prority, and task C has the lowest priority. The deadline for each task is the time when the execution cycle elapses after the task becomes executable. Thus, the deadline for task A is 1(s), the deadline for task B is 4(s), and the deadline for task C is 8(s). Reference characters “A” to “C” in the uppermost part of FIG. 8 represent the timings at which tasks A to C become executable. In the example of FIG. 8, all of tasks A to C become executable at time points t=0 and t=8. As illustrated in FIG. 3, because the execution cycle of task A is 1(s), task A becomes executable every 1(s). Task B becomes executable every 4(s), and task C becomes executable every 8(s). Note that the time points in the lower part of FIG. 8 represent the elapsed time from the time point at which all of tasks A to C become executable. Note that the deadline for task A that becomes executable at time point t=0 is time point t=1, the deadline for task B that becomes executable at time point t=0 is time point t=4, and the deadline for task C that becomes executable at time point t=0 is time point t=8. The numerical values in the parentheses on the right side of “task A” to “task C” illustrated on the left side of FIG. 8 represent the execution cycle and priority of the corresponding task. In FIG. 8, a white rectangle and a black quadrangle are combined to represent one task, and a black rectangle indicates that the task is completed. The numerical value described next to or within a rectangle represents the time from the start to the end of the task. The same applies to FIGS. 9 and 10.

In the state illustrated in FIG. 8, all of tasks A to C are successfully executed by the deadlines for the respective tasks, so there is no problem. That is, because task A starts immediately after becoming executable and finishes upon a lapse of 200 ms, task A satisfies the deadline of 1(s). When becoming executable, task B starts upon a lapse of 200 ms at which higher priority task A finishes. Then, task B finishes at the time of a lapse of 1000 m(s) since task B became executable. Task B therefore satisfies the deadline of 4(s). When becoming executable, task C does not start until: a lapse of 1000 m(s) at which higher priority tasks A and B finish; and a subsequent lapse of 200 m(s) at which task A having become executable again upon the lapse of 1000 m(s) finishes. Then, task C finishes at the time of a lapse of 1600 m(s) since task C became executable. Task C therefore satisfies the deadline of 8(s).

FIG. 9 illustrates how the controller 1 operates after the additional task information on an additional task that is task X having an execution cycle of 2(s) is temporarily registered in the task execution management table 12. The illustrated state corresponds to the operation state achieved after steps S1 to S3 illustrated in FIG. 5 are executed. Note that the original priority of additional task X is 51 between the priority of task A and the priority of task B. Because task C has the lowest priority of 101 among existing tasks A to C, the temporary priority included in the temporarily registered additional task information on additional task X is 102. In this case, additional task X is executed after the completion of task C. Because the time elapsing from when additional task X becomes executable until when additional task X is completed is less than execution cycle 2 (s), the deadline is satisfied. That is, the analysis result in step S4 illustrated in FIG. 5 indicates that additional task X satisfies the deadline. In this case, all the existing tasks (tasks A, B, and C) satisfy their deadlines even after task X is added. Therefore, the controller 1 determines that there is no influence of the addition of task X on the existing tasks. The language “influence of the addition of task X on the existing tasks” means that at least one of the existing tasks fails to satisfy the deadline due to the addition of task X. If all the existing tasks satisfy their deadlines even after task X is added, there is no “influence of the addition of task X on the existing tasks”. On the other hand, if one or more existing tasks do not satisfy their deadlines after task X is added, there is an “influence of the addition of task X on the existing tasks”. When there is no influence of the addition of task X on the existing tasks, in step S6 illustrated in FIG. 5, the controller 1 changes the priority included in the task information on additional task X from the temporary priority of 102, to the original priority of 51, and formally registers the additional task X in the task execution management table 12. As a result, the controller 1 operates as illustrated in FIG. 10.

In the example illustrated in FIG. 10, at the time of a lapse of 600 m(s) since task B started subsequently to additional task X, higher priority task A becomes executable. For this reason, the controller 1 suspends task B and executes task A. Upon completion of task A, the controller 1 executes the rest of suspended task B. Although the two parts of task B are executed separately, the time elapsing from when task B becomes executable until when task B is completed is shorter than the deadline of 4(s). Task B therefore satisfies the deadline, posing no problem. Task C to be executed subsequently to task B also satisfies the deadline of 8(s).

As described above, the controller 1 according to the present embodiment holds the task execution management table 12 in which task information is registered for use in task scheduling. In response to receiving, from the outside, in particular, from the engineering tool, new task information to be registered in the task execution management table 12, the controller 1 changes the priority included in the received task information, or additional task information, to a temporary priority lower than any priority included in the existing task information registered in the task execution management table 12. Then, the controller 1 temporarily registers the changed additional task information in the task execution management table 12. Next, in accordance with the task execution management table 12, the controller 1 executes the existing tasks and the task to be added. If the task to be added can be normally completed, the controller 1 determines that the addition of the task does not affect the existing tasks, that is, all the tasks can be normally completed even after the task is added. Note that all the tasks are the additional task and the existing tasks. If the task to be added can be normally completed, the controller 1 changes the priority included in the additional task information from the temporary priority to its original priority, and formally registers the additional task in the task execution management table 12. On the other hand, if the task to be added cannot be normally completed, the controller 1 deletes the temporarily registered additional task information from the task execution management table 12. Consequently, the controller 1 can change settings so as to execute a new task after making sure that the new task does not significantly affect the existing tasks. Therefore, while controlling an instrument at a production site or the like, the controller 1 can keep controlling the instrument normally and add a new task for execution.

In the embodiment described above, upon receiving new task information, the controller 1 changes the priority included in the received task information, or additional task information, to the temporary priority and temporarily registers the additional task information in the task execution management table 12. However, the present invention is not limited to this procedure. Upon receiving new task information, the controller 1 may temporarily register the received task information, or additional task information, in the task execution management table 12, and may change the priority included in the temporarily registered additional task information to the temporary priority.

The configuration described in the above-mentioned embodiment indicates an example of the contents of the present invention. The configuration can be combined with another well-known technique, and a part of the configuration can be omitted or changed in a range not departing from the gist of the present invention.

### REFERENCE SIGNS LIST

1 controller; 10 task execution unit; 11 scheduler; 12 task execution management table; 13 temporary priority setting unit; 14 task execution monitoring unit; 15 task execution state storage unit; 16 new task acquisition unit; 17 OS; 19 task; 101 CPU; 102 memory; 103 input/output interface; 104 field communication interface; 105 bus.

1. A controller comprising:
a processor to execute a program; and
a memory to store the program which, when executed by the processor, performs:
a process of providing a task execution management table in which task information including information on task priority is registered;
a new task acquisition process of acquiring new task information to be added to the task execution management table;
a temporary priority setting process of changing a priority included in the new task information, to a temporary priority to temporarily register the new task information in the task execution management table; and
a task execution monitoring process of monitoring an influence of execution of an additional task on execution of an existing task, the additional task being a task corresponding to the temporarily registered new task information, wherein
when the execution of the additional task does not affect the execution of the existing task, the temporary priority setting process changes the priority included in the temporarily registered task information, to the original priority set prior to being changed to the temporary priority, and formally registers the changed task information in the task execution management table.

2. A controller comprising:
a processor to execute a program; and
a memory to store the program which, when executed by the processor, performs:
a process of providing a task execution management table in which task information including information on task priority is registered;
a new task acquisition process of acquiring new task information to be added to the task execution management table;
a temporary priority setting process of temporarily registering the new task information in the task execution management table, and changing a priority included in the temporarily registered task information to a temporary priority; and
a task execution monitoring process of monitoring an influence of execution of an additional task on execution of an existing task, the additional task being a task corresponding to the temporarily registered new task information having the priority changed to the temporary priority, wherein
when the execution of the additional task does not affect the execution of the existing task, the temporary priority setting process changes the priority included in the temporarily registered task information, to the original priority set prior to being changed to the temporary priority, and formally registers the changed task information in the task execution management table.

3. The controller according to claim 1, wherein
when the additional task is successfully completed within a preset task execution cycle, the task execution monitoring process determines that the execution of the additional task does not affect the execution of the existing task.

4. The controller according to claim 1, wherein
the temporary priority setting process designates, as the temporary priority, a priority lower than any priority included in existing task information registered in the task execution management table.

5. (canceled)

6. The controller according to claim 2, wherein
when the additional task is successfully completed within a preset task execution cycle, the task execution monitoring process determines that the execution of the additional task does not affect the execution of the existing task.

7. The controller according to claim 2, wherein
the temporary priority setting process designates, as the temporary priority, a priority lower than any priority included in existing task information registered in the task execution management table.

8. The controller according to claim 3, wherein
the temporary priority setting process designates, as the temporary priority, a priority lower than any priority included in existing task information registered in the task execution management table.

9. The controller according to claim 6, wherein
the temporary priority setting process designates, as the temporary priority, a priority lower than any priority included in existing task information registered in the task execution management table.
